(19) United States
(12) Patent Application Publication
(10) Pub. No.: US 2016/0113210 A1
(43) Pub. Date: Apr. 28, 2016

(54) PLANTING PACKAGE

(71) Applicants: SHENG-LIAN LIN, Taoyuan County (TW); YU-YING LIN, Taoyuan County (TW); TUNG-YI LIN, Taoyuan County (TW)

(72) Inventors: SHENG-LIAN LIN, Taoyuan County (TW); YU-YING LIN, Taoyuan County (TW); TUNG-YI LIN, Taoyuan County (TW)

(21) Appl. No.: 14/560,738

(22) Filed: Dec. 4, 2014

(30) Foreign Application Priority Data
Oct. 22, 2014 (TW) 103136529

(51) Int. Cl. A01G 9/02; A01C 1/02

(52) U.S. Cl. CPC A01G 9/021; A01C 1/02

(57) ABSTRACT

A planting package is provided. The planting package includes a water discharging bag, a soil, at least a seed and a hanging structure, wherein the water discharging bag is made of material having water discharging function. The water discharging bag has a tear line to form a tear portion on the water discharging bag. The soil is disposed in the water discharging bag, the seed is also disposed in the water discharging bag, and the hanging structure is disposed on an outer surface of the water discharging bag. The planting package has the advantage of easily planted.

### FIELD OF THE INVENTION

The present invention relates to a planting package, and more particularly to a planting package with a hanging structure.

### BACKGROUND OF THE INVENTION

The conventional potted plant includes a pot made of pottery or plastic, a soil disposed in the pot, and a plant or a seed growing from the soil. A hole is formed at a bottom of the pot. When the soil is watered, redundant water could flow out the pot from the hole at the bottom.

In recent years, with the rise of environmental awareness, more and more people plant small potted plants at home or in the office to beautify the environment. However, the conventional potted plant has larger volume, thereby having defects of occupying more space and being difficult to carry. In addition, the conventional potted plant is often loaded in a catch basin. The redundant water in the soil can't flow out the pot from the hole at the bottom of the pot when the catch basin is filled with the water from the pot, and thus the soil may be too wet, and the growth of the plant or the seed is consequently affected.

### SUMMARY OF THE INVENTION

The present invention provides a planting package with an advantage of easily planted.

The present invention provides a planting package which includes a water discharging bag, soil, at least a seed and a hanging structure, wherein the water discharging bag is made of material having water discharging function. The water discharging bag has a tear line to form a tear portion on the water discharging bag. The soil is disposed in the water discharging bag, the seed is also disposed in the water discharging bag, and the hanging structure is disposed on an outer surface of the water discharging bag.

In an embodiment of the present invention, the water discharging bag is made of non-woven fabric.

In an embodiment of the present invention, the hanging structure includes two foldable hooks disposed on two opposite sides of the water discharging bag.

In an embodiment of the present invention, the foldable hooks are made of paper sheets.

In an embodiment of the present invention, the planting package further includes a sealed bag configured to receive the water discharging bag.

In summary, because the material of the water discharging bag has the water discharging function, the planting package could discharge redundant water easily to prevent the soil in the water discharging bag from being too wet, thereby avoiding affecting the growth of the seed. In addition, the water discharging bag can be hanged on a container or a frame through the hanging structure disposed on the outer surface of the water discharging bag to avoid the water discharging bag soaking in water, so as to avoid affecting the growth of the seed. Therefore, the planting package of the present invention has the advantage of easily planted.

### BRIEF DESCRIPTION OF THE DRAWINGS

The invention will become more readily apparent to those ordinarily skilled in the art after reviewing the following detailed description and accompanying drawings, in which:

FIG. 1 is a schematic diagram of an planting package in accordance with an embodiment of the present invention;

FIG. 2 is a schematic diagram of an planting package with a sealed bag in accordance with another embodiment of the present invention; and

FIG. 3 is a schematic diagram of the use of the planting package in accordance with an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

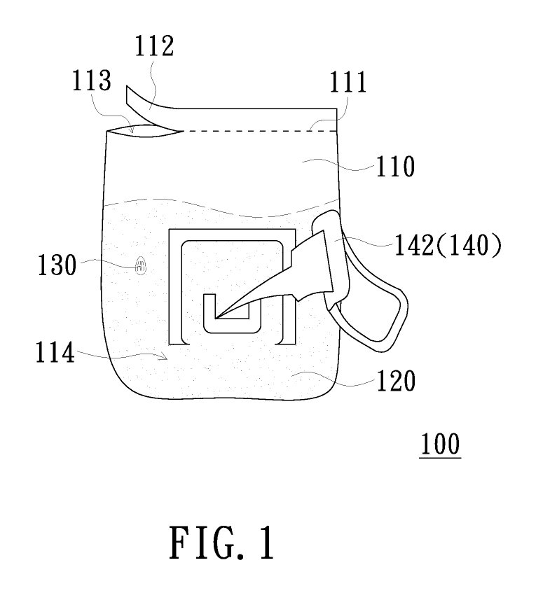

FIG. 1 is a schematic diagram of a planting package in accordance with an embodiment of the present invention. Referring to FIG. 1, the planting package 100 of the present embodiment includes a water discharging bag 110, a soil 120 and at least a seed 130, wherein the soil 120 is disposed in the water discharging bag 110 and the seed 130 is also disposed in the water discharging bag 110. In the present embodiment, the water discharging bag 110 is made of material having water discharging function such as non-woven fabric. The non-woven fabric includes holes on its surface. When the soil 120 is watered, redundant water which is not absorbed by the soil 120 could flow out the water discharging bag 110 from the holes of the surface of the non-woven fabric to avoid the soil 120 containing too much water, and further avoid affecting the growth of the seed 130. The water discharging bag 110 could also be made of other material with holes on its surface, and the present invention is not limited thereto. In addition, in the present embodiment, the soil 120 may be, but not limited to, a soil mixture for cultivating. The seed 130 could be any kind of seed or a germinated seed, and the present invention is not limited thereto.

As shown in FIG. 1, in the present embodiment, the water discharging bag 110, for example, includes a tear line 111 to form a tear portion 112 on the water discharging bag 110. When the tear portion 112 is removed by tearing along the tear line 111, an opening 113 is formed on the water discharging bag 110. The opening 113 could be served as a watering opening, and the growth of the seed 130 will not be limited in the water discharging bag 110 due to the opening 113. In addition, before the tear portion 112 is removed, the soil 120 and the seed 130 could be packed in the water discharging bag 110 without dropping out. Therefore, the planting package 100 can be conveniently carried or transported.

In the present embodiment, the planting package 100 further includes a hanging structure 140 disposed on an outer surface 114 of the water discharging bag 110 to hang the water discharging bag 110. The hanging structure 140, for example, includes two foldable hooks 142 disposed on two opposite sides of the water discharging bag 110 (only one side is shown in FIG. 1). Since the foldable hooks 142 of the present embodiment are easily folded, the hanging structure 140 has a space saving advantage. In addition, for environmental protection, the foldable hooks 142 could be made of paper sheets. It should be noted that the hanging structure 140 is not limited to the above-mentioned foldable hooks 142. The hanging structure 140 could be any other structure with hanging function.

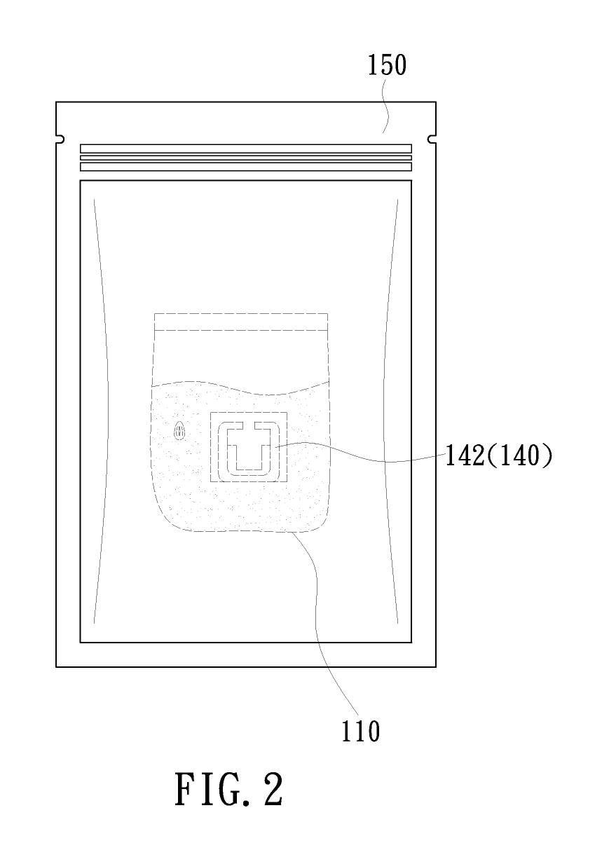

In the present embodiment, as shown in FIG. 2, the planting package 100 may further includes a sealed bag 150 configured to receive the water discharging bag 110. Thus, the sealed bag 150 could not only prevent the water discharging bag 110 or the hanging structure 140 from being damaged in the process of transporting or carrying, but also prevent the soil 120 in the planting package 100 which is not used from being wet. The sealed bag 150 may be, but not limited to, an aluminum foil bag. Moreover, the sealed bag 150 is, for example, filled with nitrogen gas to improve the effects of wet proof and quality guarantee.

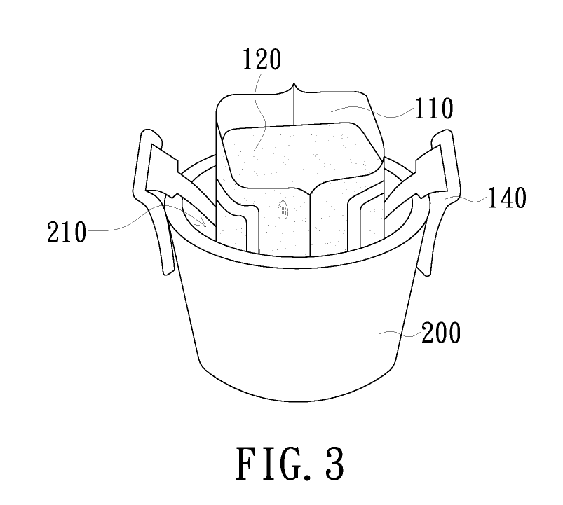

When using the planting package 100, the user only needs to tear the sealed bag 150 and take out the water discharge bag 110, and then remove the tear portion 112 by tearing along the tear line 111, so as to water the soil 120. Therefore, the planting package 100 has the advantage of easily planted. For example, as shown in FIG. 3, the water discharging bag 110 could be hanged on a cup 200 by the hanging structure 140. When the soil 120 is watered, the water flowing from the surface of the water discharging bag 110 could flow to a bottom of the cup 200. Because the water discharging bag 110 is hanged in a receiving space 210 of the cup 200 by the hanging structure 140, the water discharging bag 110 would not contact with the bottom of the cup 200, thereby avoiding soaking the water discharging bag 110 in the water in the cup 200. Thus, the soil 120 will not be too wet, and the growth of the seed 110 will not be affected. According to specific requirements, the water discharging bag 110 could be hanged on other container or frame by the hanging structure 140, and the present invention is not limited thereto.

In summary, because of the water discharging function of the material of the water discharging bag, the planting package of the present invention could easily discharge redundant water to prevent the soil in the water discharging bag from being too wet, thereby avoiding affecting the growth of the seed. In addition, the planting package includes the hanging structure disposed on the outer surface of the water discharging bag, so that the water discharging bag could be hanged in receiving space of a container to avoid soaking in the water and to avoid affecting the growth of the seed. Therefore, the planting package of the present invention has the advantage of easily planted.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A planting package, comprising:
a water discharging bag made of material having water discharging function, wherein the water discharging bag comprises a tear line to form a tear portion on the water discharging bag;
a soil disposed in the water discharging bag;
at least a seed disposed in the water discharging bag; and
a hanging structure disposed on an outer surface of the water discharging bag.

2. The planting package according to claim 1, wherein the water discharging bag is made of non-woven fabric.

3. The planting package according to claim 1, wherein the hanging structure comprises two foldable hooks disposed on two opposite sides of the water discharging bag.

4. The planting package according to claim 3, wherein the foldable hooks are made of paper sheets.

5. The planting package according to claim 1, further comprising a sealed bag configured to receive the water discharging bag.
